(19) United States
(12) Patent Application Publication
(10) Pub. No.: US 2002/0074679 A1
(43) Pub. Date: Jun. 20, 2002

(54) Method for manufacturing multi-layered, air-gapped sheet of chitosan

(76) Inventors: Won K. Kim, Suh-Goo (KR); Min J. Kim, Suh-Goo (KR); Hyun O. Yoo, Kangnam-Goo (KR); Tea W. Son, Soosung-Goo (KR); Bong K. Park, Suh-Goo (KR)

Correspondence Address: JOHN K. PARK, PARK & SUTTON LLP, SUITE 1110, 3255 WILSHIRE BLVD., LOS ANGLES, CA, 90010, US

(21) Appl. No.: 09/975,772

(22) Filed: Oct. 12, 2001

(30) Foreign Application Priority Data
Oct. 17, 2000 (KR) 2000-0061106

(51) Int. Cl. B29C 65/00

(52) U.S. Cl. 264/41

(57) ABSTRACT

Disclosed is a method for manufacturing a multi-layered, air-gapped sheet of chitosan, which is a novel form of chitosan. For the preparation of a multi-layered, air-gapped sheet of chitosan, chitosan is first dissolved in a weak acidic solution to form a chitosan solution. The chitosan solution is incubated at −5° C. to 50° C. for 1 to 30 days. The chitosan solution is than dried by a freeze-drying process, thermal drying process, or vacuum drying process. In freeze-drying, a freezing the chitosan solution at −10° C. to −60° C. and a heating it at 50° C. to 100° C. under a pressure of 100 Torr to 0.1 Torr are alternately repeated several times for about 10 minutes to about 120 minutes for each freezing or heating process. In thermal drying, a heating the chitosan solution at 50° C. to 200° C. and an incubating it at −5° C. to 50° C. are alternately repeated several times for about 10 minutes to about 120 minutes for each process. In vacuum drying, the same procedure of thermal drying is conducted with the exception that the heating in vacuum drying is performed under a pressure of 100 Torr to 0.1 Torr.

### CLAIMING FOREIGN PRIORITY

The applicant claims and requests a foreign priority, through the Paris Convention for the Protection of Industry Property, based on a patent application filed in Korea with the filing date of Oct. 17, 2000, with the patent application number 2000-0061106, by the applicant. (See the Attached Declaration)

### BACKGROUND OF THE INVENTION

1. Field of the Invention

The present invention relates to a method for manufacturing a multi-layered, air-gapped sheet of chitosan, which comprises a plurality of films of chitosan. The multi-layered, air-gapped sheet of chitosan can prolong the retention time of drugs therein and allow the uniform distribution of the drug therethroughout.

2. Description of the Prior Art

Chitin is abundantly found in the shells of insects and crustaceans such as crabs and shrimps and in the cell walls of fungi, mushrooms, and bacteria. Along with potassium carbonate, proteins, lipids, and pigments, chitin serves to comprise the main structure of shells and exoskeletons of various animals. Next to cellulose, chitin is the second most produced polysaccharide in the world. It is estimated that ten billion tons of chitin and its derivatives are produced from living organisms each year.

In spite of its abundance in nature, chitin has not been effectively utilized because of its low solubility in aqueous solutions. As a result of low solubility in aqueous solutions, chitin is difficult to form into fibers or films and thus, has found limited applications. In an effort to overcome this problem, chitin was converted into chitosan ((C₆H₁₁NO₄)ₙ) which is soluble in aqueous acid solutions. A deacetylation technique is generally used for the conversion of chitin into chitosan. Industrially, chitosan, which is water-soluble, is more extensively used than chitin, which is non-water soluble.

Derived from chitin, chitosan, which is an aminopolysaccharide represented by the following chemical formula 1, is known as being bio-friendly because it is non-toxic and biodegradable. In addition, chitosan was found to have biological properties such as antibacterial activity and biocompatibility. With these properties, chitosan has been used effectively in a variety of biological applications, such as cell fusing, tissue culturing, and hemorrhage stopping. Furthermore, chitosan has been applied in various physiological functions including reduction of blood cholesterol and sugar levels, activation of intestinal metabolism, anticancer activity through immunological enhancement, improvement of liver activity, and counteractivity against metal poisoning.

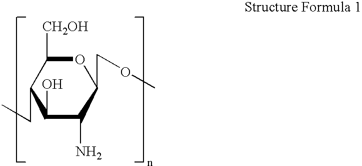

Initially, chitin and chitosan were used as coagulants to recover useful materials from the wastewater of food factories. Recently, numerous applications of chitin and chitosan have been found in a variety of industries, including food, pharmaceutical and medicine, bioengineering, cosmetic, agricultural, chemical engineering, and environmental industries.

Thus far, wastes from crustaceans, such as crabs and shrimp, have been used as main sources for chitin. In the future, it is expected for chitin to be obtained from krill. With respect to the sources of chitosan, fungi are considered as a potential source because they are found to contain chitosan as well as chitin in their cell walls. Thus, the sources of chitosan will be expanded if techniques for culturing fungi and extracting chitosan from fungi are developed.

U.S. Pat. No 3,533,940 discloses a method for preparing chitosan from chitin, along with application of chitosan to fibers and films. For this application, the prepared chitosan is dissolved in aqueous organic solutions. In U.S. Pat. No. 4,699,135, it is disclosed that chitin is dissolved in polar solvents such as lithium chloride-containing dimethyl acetate amide to produce chitin fibers. In addition, disclosed is the production of chitosan staples from a solution of chitosan in which chitosan is dissolved in an aqueous acetic acid solution. U.S. Pat. No. 5,900,479 describes the production of films and fibers of water-insoluble chitin from an aqueous organic acid solution of chitosan. U.S. Pat. No. 4,286,087 introduced a process of manufacturing chitin powder by treating a particulate chitin at an elevated temperature with phosphoric acid which is diluted with a lower aliphatic alcohol, separating the treated chitin and shearing it in an inert liquid medium until a uniform dispersion is obtained, thereafter separating the sheared chitin, drying, and grinding it to a fine powder.

In addition to the techniques for utilizing chitin or chitosan as raw materials in producing films and fibers, active research has been directed to the production of biocompatible and hygienic products, which are suitable for being used in clinical medicine fields. Furthermore, potential applications of the biocompatible and hygienic products have been studied. As a result, various techniques regarding these products and their applications are developed and disclosed at present.

As an example of the techniques for clinical medicine purposes, Dynesh et al. (Rev. Macromol. Chem. Phys., C40(1), 69-83 (2000)) reported research results describing the applicability and superior functionalities of chitin, chitosan, and derivatives thereof as materials for use in wound healing agents, artificial skins, pharmaceuticals, blood coagulants, artificial kidney membranes, biodegradable sutures, and antibacterial agents. Another research result can be referred to Maryefan et al. (ILEE Engineering In Medicine and Biology November/December, 1999). Maryefan et al. reported that bedcovers with a coating of chitosan have the medicinal effects of preventing the formation of cicatrices and facilitating wound healing.

In addition, Lithbethylem et al. (Pharmaceutical Research, Vol. 15, No. 9, 1988) reported that, due to its properties of non-toxicity and biocompatibility, chitosan has numerous applications in the pharmaceutical industry. According to Lithbethylem et al., examples of the applications are binders for drug, wetting agents, gel films, emulsifying agents, coating agents, microcapsules, bio-adhesives, official preparations, vaccine derivatives, and gene derivatives.

Furthermore, a research result published by Wang, K. R. et al. (Journal of Biomedical Materials Research, V. 53, N. 1, 8-17, 2000) discloses that due to the high moisture permeability of chitosan a wound dressing comprising chitin and chitosan acetate, when being applied to second degree burns, prevented the accumulation of wound exudates. It is also disclosed that the wound dressing comprising chitin and chitosan acetate prevented the secondary infection due to the antibacterial activity of chitosan.

U.S. Pat. No. 5,836,970 relates to wound dressings comprising a mixture of effective amounts of chitosan and alginate, both of which can be provided in form of a powder, film, or gel. It is asserted that the wound dressings have the properties of accelerating wound healing.

U.S. Pat. Nos. 3,632,754 and 3,914,413 teach that chitin has the effect of facilitating wound healing and is physiologically soluble through its hydrolysis by lysozyme.

In both European Pat. No. EP0089152 and Japanese Pat. No. 86141373, it is disclosed that composite films prepared from chitin with keratin or collagen are used as wound protectives.

With such physiologically effective advantages, chitin and chitosan have been utilized in a variety of commercialized products. For example, health foods manufactured by Choito-Bios Company and Acona Company, which are German companies, are known to utilize chitin and chitosan. Wella Company, Italy, uses hydrolyzed chitosan in hair protection products. Other examples of commercialized products utilizing chitin or chitosan or both include the diet food Evalson R of Nihon Kayaku, Japan, CM-chitin (a skin protective) of Ichimarn Farukosu, Japan, chitin non-woven fabric and chitin fiber used as biodegradable surgical suture of Yunichika, Japan, and chitosan-collagen material used as artificial skin of Katakurachkkarin, Japan.

Although many researchers have recognized chitin or chitosan as a body-adaptable material, clinical applications of chitin and chitosan are still in their initial stages. No conventional techniques disclose manufacturing methods of effective forms of chitosan to exert its beneficial functions maximally for various purposes. Sonyasalmon et al. (Gout-Ilal of Polymer Sci. Part B: Polymer Physics, Vol. 33, 1007-1014 (1995)) reported that only one-dimensionally structured fibers of chitosan could be manufactured. Later, the possibility for an advanced form of chitosan was suggested by Kenziokuyoma et al. (Macromolecular 1997, 30, 5849-5855), based on the theory that hydrated chitosan molecules are able to form a two-dimensional structure during crystallization. However, Kenziokuyoma et al. failed to develop their theory into practically applicable forms Of chitosan, which can be applied for various clinical-pathological treatments with maximal functionality. The following structure formula 2 shows the two-dimensional structure of chitosan as suggested by Kenziokuyoma et al.

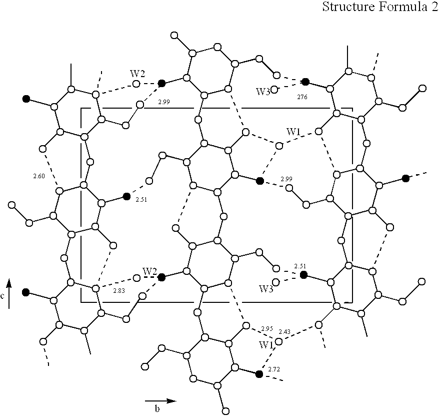

Conventional chitosan products are usually in forms of films, non-woven fabrics, or foaming sheets with simple exposed or closed space in cross section view. With those forms of conventional chitosan products, high retention capability and uniform distribution of drugs in such structures cannot be expected at all.

### SUMMARY OF THE INVENTION

The object of the present invention is to overcome the above problems encountered in prior arts. To accomplish this object, the present invention provides a method for manufacturing a multi-layered, air-gapped sheet of chitosan. The multi-layered, air-gapped sheet of chitosan comprises a plurality of films of chitosan. The each film of chitosan is stacked next to one another, with a gap therebetween, with the upper film surface facing the lower film surface of an adjacent film. Said each film of chitosan is between 0.1 μm and 50 μm in thickness, and the gap is between 1 μm and 10,000 μm. The each film of chitosan is arranged in the direction substantially perpendicular or horizontal to the top surface of the multi-layered, air-gapped sheet, or in the slanting direction to the top surface of the sheet. Some multi-layered, air-gapped sheet of chitosan comprises a plurality of sub-sheets of chitosan. Each sub-sheet of chitosan itself is a multi-layered, air-gapped sheet of chitosan, and any two sub-sheets next to each other are not identical each other. The multi-layered, air-gapped sheet of the present invention has a void volume ratio of 20% to 99%. Due to large surface area and substantially regular arrangement of the films and gaps in the multi-layered, air-gapped sheet of chitosan, drugs can be uniformly distributed throughout this structure as well as can be retained in the structure for a long period of time.

The multi-layered, air-gapped sheet of chitosan is manufactured by the following steps: (1) dissolving chitosan in a weak acidic, aqueous organic acid solution to give a chitosan solution, (2) incubating the chitosan solution for 1 to 30 days at −5° C. to 50° C. so that molecular chains of chitosan are arranged in a plane to form films, and (3) drying the chitosan solution by freeze-drying, thermal drying, or vacuum drying at substantially regular time intervals so as to establish multi-layered structure and to extract the multi-layered, air-gapped sheet of chitosan from the solution.

During a freeze-drying process in the above step (3), the chitosan solution is frozen and then dried under high vacuum condition through sublimation without going through a liquid phase. In other words, the direct transition from the frozen solvent of the chitosan solution to gaseous solvent occurs under extremely low pressure. In a thermal drying method, liquid solvent of chitosan solution is removed by evaporation when it is heated. On the contrary, in a vacuum drying process, the liquid solvent evaporates when the pressure of the solution environment is extremely lowered.

### BRIEF DESCRIPTION OF THE DRAWINGS

FIG. 1 schematically shows multi-layered, air-gapped structures of chitosan sheets, in which films of chitosan are laminated with a gap therebetween in perpendicular, slanting, and horizontal directions, respectively.

FIG. 2 schematically illustrates multi-layered, air-gapped sheets of chitosan comprising two different kinds of sub-sheets of chitosan.

FIG. 3 is an electron microphotograph of a longitudinal cross-section of a multi-layered, air-gapped sheet of chitosan, showing a multi-layered structure in which films of chitosan, each 5-10 μm thick, are stacked next to one another with gaps therebetween of 20-120 μm in the direction substantially perpendicular to the top surface of the sheet.

FIG. 4 is an electron microphotograph of a longitudinal cross-section of a multi-layered, air-gapped sheet of chitosan, showing a multi-layered structure in which films of chitosan, each 5-10 μm thick, are stacked next to one another with gaps therebetween of 20-120 μm in the slanting direction against the top surface of the sheet.

FIG. 5 is an electron microphotograph of a longitudinal cross-section of a multi-layered, air-gapped sheet of chitosan, showing a multi-layered structure in which films of chitosan, each 5-10 μm thick, are stacked next to one another with gaps therebetween of 60-360 μm in the direction substantially horizontal to the top surface of the sheet.

FIG. 6 is an electron microphotograph of a longitudinal cross-section of a multi-layered, air-gapped sheet of chitosan comprising two sub-sheets of chitosan, showing a multi-layered structure in which the films of the first sub-sheet of chitosan, each 5-10 μm thick, are stacked next to one another with gaps therebetween of 50-220 μm in the direction substantially horizontal to the top surface of the first sub-sheet while the films of the second sub-sheet of chitosan, each 5-10 μm thick, are stacked next to one another with gaps therebetween of 50-220 μm in the direction slanting against the top surface of the second sub-sheet.

### DETAILED DESCRIPTION OF THE INVENTION

The present invention discloses a method for manufacturing a multi-layered, air-gapped sheet of chitosan, which comprises a plurality of films of chitosan. A multi-layered, air-gapped sheet of chitosan will be explained first with reference to the accompanying drawings, and the method for manufacturing the multi-layered, air-gapped sheet of chitosan will be described.

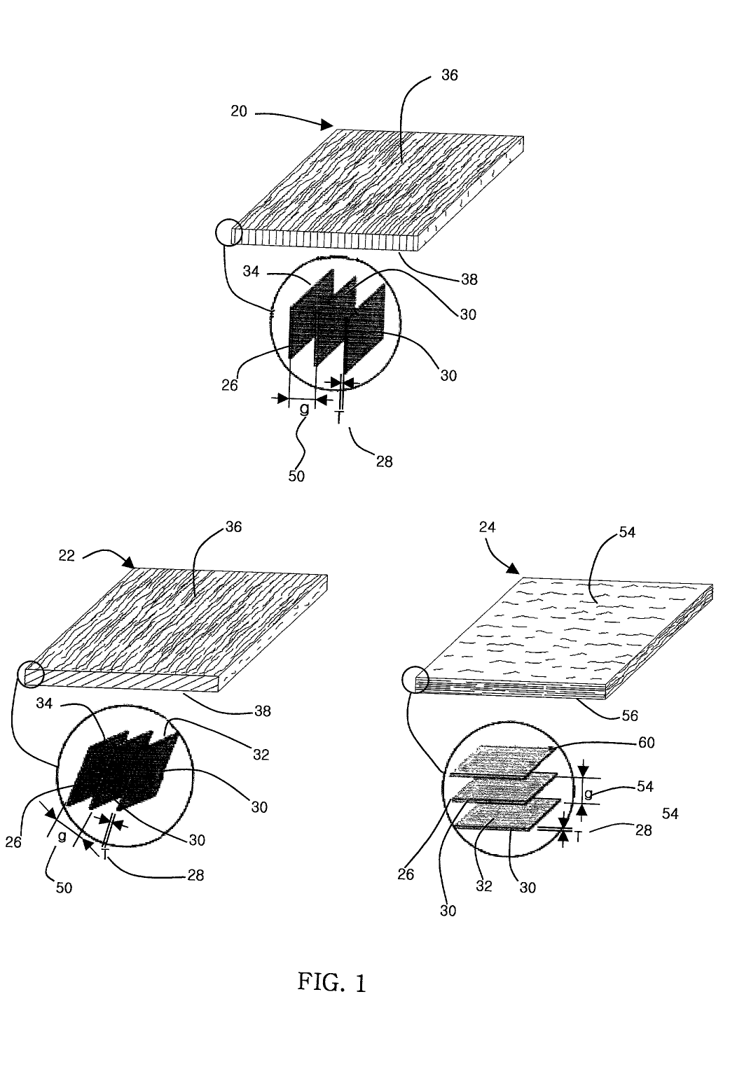

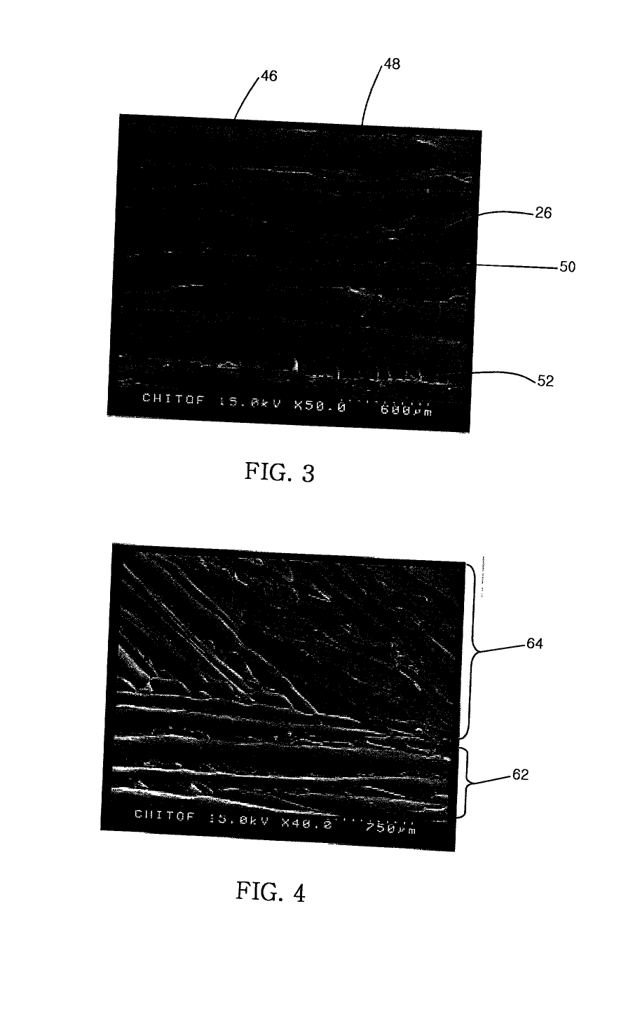

As shown in FIGS. 1 through 6, there are various kinds of multi-layered, air-gapped sheets of chitosan 20, 22, 24, 40, 42, 44, and 66. Each multi-layered, air-gapped sheet of chitosan comprises a plurality of films of chitosan 26. Each film of chitosan 26 is between 0.1 μm and 50 μm in thickness, T, 28. Said each film of chitosan 26 has a lower film surface 30 and an upper film surface 32. In each multi-layered, air-gapped sheet of chitosan 20, 22 and 24, the each film 26 is stacked next to one another with the upper film surface 32 facing the lower film surface 30 of an adjacent film. In addition, the lower film surface and the upper film surface of the each film 26 are substantially parallel to the lower film surface and the upper film surface of an adjacent film.

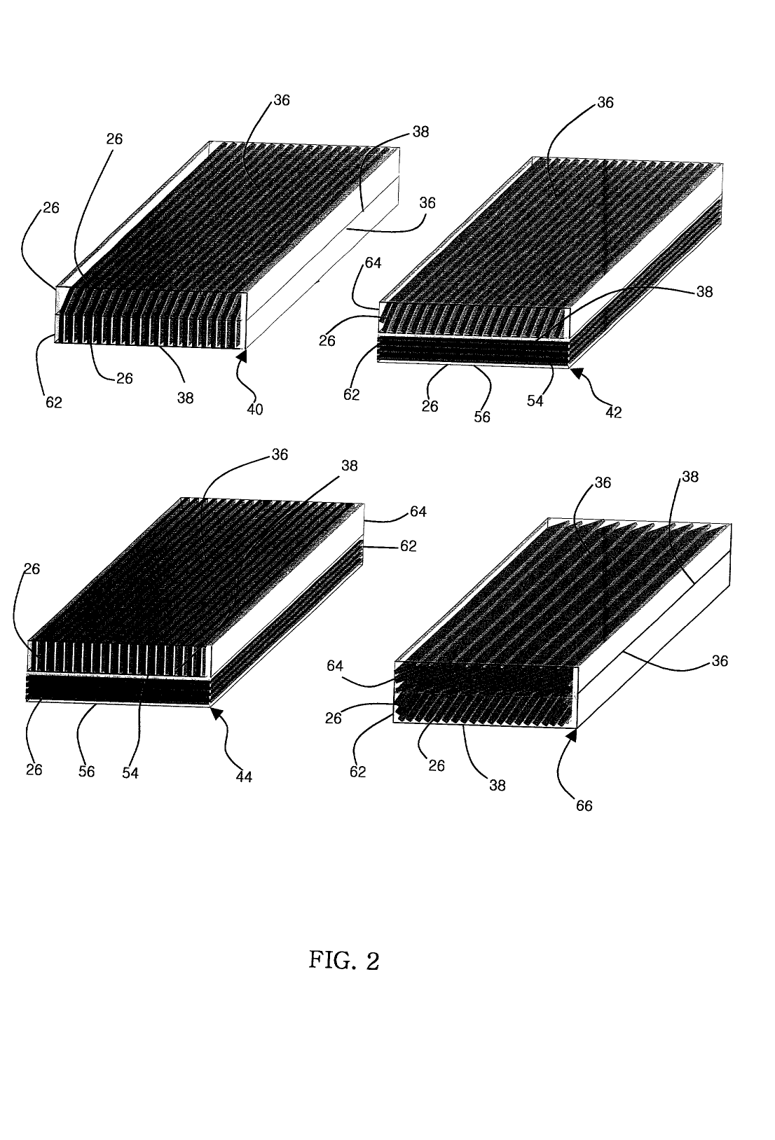

Although the lower film surface 30 and the upper film surface 32 are illustrated as flat in the schematic drawings of FIGS. 1 and 2, the real lower film surface and the real upper film surface of the each film are uneven as shown in FIGS. 4 through 6. Said each film 26 has peaks 46 and valleys 48 on the lower film surface 30 and the upper film surface 32. The peaks 46 and the valleys 48 are various in shape, height, and width. Therefore, the peaks 46 and the valleys 48 on the upper film surface 32 do not conform to the peaks and the valleys on the lower film surface of an adjacent film. As a result, a gap, g, 50 is formed where the valley 48 on the upper film surface 32 of the each film 26 is not contacted with the peak 46 on the lower film surface 30 of an adjacent film. The gap, g, 50 is also formed where the peak 46 on the upper film surface 32 of the each film 26 does not contact with the valley 48 or the peak 46 on the lower film surface 30 of an adjacent film. The gap, g, 50 between two adjacent films is between 1 μm to 10,000 μm.

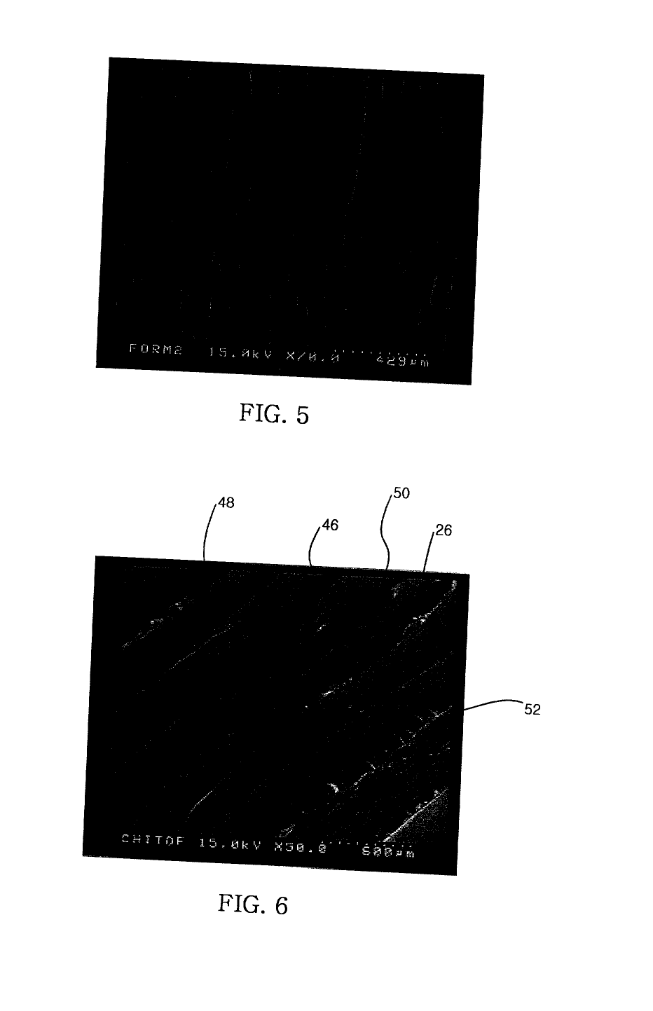

As shown in FIGS. 4 and 5, the each film 26 has a capillary-like protrusion of chitosan 52 on the lower film surface 30 and the upper film surface 32 of the each film 26. The capillary-like protrusion of chitosan 52 of the each film 26 is attached to an adjacent film so that it functions as a support for the multi-layered structure.

In some multi-layered, air-gapped sheets of chitosan 20, 22, a series of a perimeter 34 of the each film 26 collectively forms a top surface 36 and a bottom surface 38 of the multi-layered, air-gapped sheets of chitosan 20, 22. In one form of a multi-layered, air-gapped sheet of chitosan 20, each film 26 is arranged in the direction substantially perpendicular to the top surface 36 of the sheet 20. In other words, said each film 26 is stacked next to one another so that the lower film surface 30 (or the upper film surface 32) of the film 26 and the top surface 36 (or the bottom surface 38) of the sheet 20 substantially form about 90° angle. In another form of a multi-layered, air-gapped sheet of chitosan 22, each film 26 is laminated next to one another so that the upper film surface 32 of the each film 26 and the top surface 36 of the sheet 22 substantially form less than or greater than about 90° angle. Therefore, the each film 26 is stacked in the direction slanting against the top surface 36 of the sheet 22.

In the third type of a multi-layered, air-gapped sheet of chitosan 24, the each film 26 is stacked next to one another so that the lower film surface 30 and the upper film surface 32 of the each film 26 are substantially parallel to a top surface 54 and a bottom surface 56 of the sheet 24. In this multi-layered, air-gapped sheet of chitosan 24, the bottom surface 56 of the sheet 24 is the lower film surface 30 of a first film of chitosan 58, and the top surface 54 of the sheet 24 is the upper film surface 32 of a last film of chitosan 60.

As shown in FIGS. 2 and 6, some multi-layered, air-gapped sheets of chitosan 40, 42, 44, and 66 comprise a plurality of sub-sheets of chitosan 62, 64. The each sub-sheet of chitosan 62, 64 itself is a multi-layered, air-gapped sheet of chitosan 20, 22, and 24 which is described above. Said each sub-sheet 62 is stacked next to one another with the top surface 36 facing the bottom surface 38 of an adjacent sub-sheet 64. Among the plurality of the sub-sheets of chitosan, any two sub-sheets next to each other are not identical each other. Therefore, there are four different combinations of the two sub-sheets next to each other as illustrated in FIG. 5.

In the first type of combination of the two sub-sheets 62, 64 in a multi-layered, air-gapped sheet of chitosan 40, the each film 26 of a first sub-sheet of chitosan 62 is stacked next to one another in the direction substantially perpendicular to the top surface 36 of the sub-sheet 62, and the each film 26 of a second sub-sheet of chitosan 64 is stacked next to one another in the direction substantially slanting against the top surface 36 of the second sub-sheet 64. In other words, the series of the perimeter of the each film 26 in the first sub-sheet of chitosan 62 collectively forms the top surface 36 and the bottom surface 38 of the first sub-sheet 62, and the lower film surface 30 of the each film 26 in the first sub-sheet 62 and the top surface 36 of the first sub-sheet 62 substantially form about 90° angle. With respect to the second sub-sheet 64, a series of the perimeter of the each film 26 in the second sub-sheet 64 collectively forms the top surface 36 and the bottom surface 38 of the second sub-sheet, and the lower film surface 30 of the each film 26 in the second sub-sheet 64 and the top surface 36 of the second sub-sheet 64 substantially form less than or greater than about 90° angle.

In the second type of combination of the two sub-sheets 62, 64 in a multi-layered, air-gapped sheet of chitosan 42, the each film 26 in a first sub-sheet of chitosan 62 is stacked next to one another so that the lower film surface 30 and the upper film surface 32 of the each film 26 are substantially parallel to the top surface 54 and the bottom surface 56 of the first sub-sheet 62. Regarding a second sub-sheet 64 in the multi-layered, air-gapped sheet of chitosan 42, a series of the perimeter of the each film 26 in the second sub-sheet 64 collectively forms the top surface 36 and the bottom surface 38 of the second sub-sheet 64. The lower film surface 30 of the each film 26 in the second sub-sheet 64 and the top surface 36 of the second sub-sheet 64 substantially form less than or greater than about 90° angle.

Thirdly, in a multi-layered, air-gapped sheet of chitosan 44, the each film 26 in a first sub-sheet of chitosan 62 is stacked next to one another so that the lower film surface 30 and the upper film surface 32 of the each film 26 are substantially parallel to the top surface 54 and the bottom surface 56 of the first sub-sheet 62. In a second sub-sheet 64 of the multi-layered, air-gapped sheet of chitosan 44, a series of the perimeter of the each film 26 in the second sub-sheet of chitosan 64 collectively forms the top surface 36 and the bottom surface 38 of the second sub-sheet 64. The lower film surface 30 of the each film 26 in the second sub-sheet 64 and the top surface 36 of the second sub-sheet 64 substantially form about 90° angle.

Fourthly, in a multi-layered, air-gapped sheet of chitosan 66, a series of the perimeter of the each film 26 in a first sub-sheet 62 collectively forms the top surface 36 and the bottom surface 38 of the first sub-sheet 62. The lower film surface 30 of the each film 26 in the first sub-sheet 62 and the top surface 36 of the first sub-sheet 62 substantially form less than or greater than about 90° angle. Similarly, in a second sub-sheet 64 of the multi-layered, air-gapped sheet of chitosan 66, a series of the perimeter of the each film 26 in the second sub-sheet 64 collectively forms the top surface 36 and the bottom surface 38 of the second sub-sheet 64. The lower film surface 30 of the each film 26 in the second sub-sheet 64 and the top surface 36 of the second sub-sheet 64 substantially form less than or greater than about 90° angle. However, the angle formed in the first sub-sheet 62 and the angle formed in the second sub-sheet 64 are not same.

Having numerous applications in various industries, including the food industry, the medical industry, the cosmetic industry, the agricultural industry, the chemical engineering industry, and the environmental industry, the multi-layered, air-gapped sheets of chitosan have a complex three-dimensional morphology quite different from those of fibers, films, powders, and the like, which prior arts suggest. With such a novel three-dimensional structure, therefore, the multi-layered, air-gapped sheet of chitosan is suitable particularly for uses in medical applications, including wound healing agents, artificial skins, pharmaceuticals, blood coagulants, artificial kidney membranes, and antibacterial agents. Since the arrangements of the each film 26 and the each gap, g, 50 in the multi-layered, air-gapped sheets of chitosan 20, 22, 24, 40, 42, 44, and 66 are substantially regular and orderly, drugs can be retained for a prolonged period of time and be dispersed homogeneously throughout the sheets 20, 22, 24, 40, 42, 44, and 66. Therefore, drug retention and distribution are greatly improved in the sheets of the present invention. In addition, the multi-layered, air-gapped sheets of chitosan 20, 22, 24, 40, 42, 44, and 66 show high air and water permeability, drug delivery rate, and water solubility.

For instance, the multi-layered, air-gapped sheets of chitosan 20, 22, 24, 40, 42, 44, and 66, when being used as wound dressings, can effectively remove wound exudates, facilitate ventilation to the wound due to their high air permeability, and effectively apply drugs to the wound.

Moreover, in the pharmaceutical industry, a material is required to form a moldable solution in order to be used as binders for drug, wetting agents, gel, films, emulsifying agents, coating agents, microcapsules, and bio-adhesives. In this aspect, the multi-layered, air-gapped sheets of chitosan is highly suitable for use as a chitosan source for a broad spectrum of applications because it can be readily dissolved in water owing to its large surface area.

For the preparation of a multi-layered, air-gapped sheet of chitosan, chitosan ((C₆H₁₁NO₄)ₙ) is first dissolved in a weak-acidic solvent in a particular weight ratio. Suitable in the present invention is chitosan which ranges in polymerization degree from 10 to 100,000 and in deacetylation degree from 60% to 99%. More preferable is chitosan which ranges in polymerization degree from 100 to 10,000 and in deacetylation degree from 70% to 95%. Any solvent may be used as long as it is aqueous acidic solution, aqueous inorganic salt solution, or organic solvent.

To obtain an aqueous acidic solution suitable in the present invention, water is added with 0.1-20 wt % of an acid which is selected among organic acid group such as acetic acid, lactic acid, formic acid, glycolic acid, acrylic acid, propionic acid, succinic acid, oxalic acid, ascorbic acid, gluconic acid, tartaric acid, maleic acid, citric acid, glutamic acid, and mixtures thereof.

Inorganic salt solutions suitable in this invention contain an inorganic salt at an amount of 10-70 wt % in water. The inorganic salt is selected from the group consisting of sodium thioisocyanate, zinc chloride, calcium chloride, sodium chloride, potassium chloride, lithium chloride, and mixtures thereof.

In the selected solvent, chitosan is dissolved at about 0.5% to about 30% by weight to give a chitosan solution which is then incubated for 1 to 30 days at −5° C. to 50° C. The incubation process provides an environment under which molecular chains of chitosan are potentially arranged in a plane so as to form a film, as inferred from the structure (structure formula 2, supra) suggested by Kenziokuyoma (Macromolecular, supra).

The incubated chitosan solution is then dried to extract a multi-layered, air-gapped sheet of chitosan from the solution. There are various possible ways in drying, including freeze-drying, thermal drying, and vacuum drying. Among the three drying methods, the freeze-drying method is preferred. Over ordinary drying techniques, the freeze-drying technique has the advantage of producing higher quality products because the drying process is performed at a comparatively low temperature. In addition, freeze-dried products have slightly porous structures.

In freeze-drying, firstly the chitosan solution is pre-frozen at a temperature ranging from −10° C. to −60° C. and more preferably at a temperature ranging from −35° C. to −40° C. The pre-freezing temperature has a great influence on the final product, and so must be carefully controlled. The frozen chitosan solution is heated at 50° C. to 100° C. for about 10 minutes to about 120 minutes under a pressure of 100 Torr to 0.1 Torr. The freezing process at −10° C. to −60° C. and the heating process at 50° C. to 100° C. under a pressure of 100 Torr to 0.1 Torr are alternately repeated several times for about 10 minutes to about 120 minutes for each process. The each process is performed at about the same time intervals between the processes.

During this drying process, sublimation of solvent and dehydration occur. The solvent and the moisture are gradually removed from the top of the frozen phase by sublimation while a porous structure of a plurality of films of chitosan appears. As the sublimation boundary travels downward, the multi-layered, air-gapped structure becomes larger. At last, the frozen phase disappears while a water-soluble, multi-layered, air-gapped sheet of chitosan is obtained in which the plurality of chitosan films are arranged with gaps therebetween in a substantially orderly way in the direction perpendicular or horizontal to the top surface of the sheet, or slanting against the top surface of the sheet.

In a thermal drying method, the incubated chitosan solution is initially heated at 50° C. to 200° C. for about 10 minutes to about 120 minutes. The chitosan solution is then incubated at −5° C. to 50° C. for about 10 minutes to about 120 minutes. The heating the chitosan solution at 50° C. to 200° C. and the incubating it at −5° C. to 50° C. are alternately repeated several times for about 10 minutes to about 120 minutes for each process. The each process is performed at about the same time intervals between the processes.

In vacuum drying, the incubated chitosan solution is initially heated at 50° C. to 200° C. for about 10 minutes to about 120 minutes under a pressure of 100 Torr to 0.1 Torr. The chitosan solution is then incubated at −5° C. to 50° C. for about 10 minutes to about 120 minutes. The heating the chitosan solution at 50° C. to 200° C. under a pressure of 100 Torr to 0.1 Torr and the incubating it at −5° C. to 50° C. are alternately repeated several times for about 10 minutes to about 120 minutes for each process. The each process is performed at about the same time intervals between the processes.

During the above drying procedures, a plurality of chitosan films 26, each ranging from 0.1 μm to 50 μm in thickness, T, 28, are arranged so that the lower film surface 30 of the each film 26 and the top surface 36 or 54 of the multi-layered, air-gapped sheet substantially form about 90° angle, less than or greater than about 90° angle, or about zero degree (0°) angle. Drying environment and drying pattern, such as the length of each heating or freezing/incubating process and the level of consistency in temperature and pressure, are thought to influence on determining whether the angle formed between the each film and the top surface of the sheet would be about 90°, less than or greater than about 90°, or about zero degree (0°). It is also believed that a modest stirring the chitosan solution during the incubation process in thermal and vacuum drying may also influence on formation of the angle.

The multi-layered, air-gapped sheet of chitosan prepared above ranges in bulk density from 0.01 to 1.0 g/cm³ and more preferably from 0.05 to 0.5 g/cm³.

Defined as a proportion of the total volume minus the volume of the films to the total volume of the sheet, a void volume ratio is measured to be between 99% and 20% in the multi-layered, air-gapped sheet of chitosan.

$$Void volume ratio = \frac{total volume of the sheet \text{-} volume of the films}{total volume of the sheet}$$

A better understanding of the present invention may be obtained in light of the following examples which are set forth to illustrate, but are not to be construed to limit the present invention.

### Preparation of Multi-layered, Air-gapped Sheet of Chitosan

### EXAMPLE 1

1. Preparation of Chitosan Solution

In 95 g of an aqueous 3 wt % lactic acid solution was dissolved 5 g of chitosan which was 116 cps in viscosity with a deacetylation degree of 94% to give a transparent solution. Incubation at 30° C. for 3 days provided the condition under which the molecular chains of chitosan could be arranged in a plane so as to form films.

2. Pre-Freezing Treatment

The chitosan solution thus obtained was placed in a container of a freeze-drier and frozen at as low as −50° C.

3. Freeze Drying

The pre-frozen chitosan solution was subjected to freeze-drying at a pressure of 0.1 Torr for 120 minutes by heating the chitosan solution at 50° C. Cycling the chitosan solution between the freezing the chitosan solution at as low as −50° C. and the heating at 50° C. at 0.1 Torr was then performed for 120 minutes for each cycle to produce a multi-layered, air-gapped sheet of chitosan.

### EXAMPLE 2 TO 5

### Properties of Multi-layered, Air-gapped Sheets of Chitosan According to Chitosan Viscosities

The same procedure of Example 1 was conducted with the exception that 3 g of each of chitosans which had viscosities of 11.6 cps, 116 cps, 370 cps, and 1,446 cps, respectively, all being deacetylated at 94%, and an aqueous 5 wt % lactic acid solution was used, so as to form multi-layered, air-gapped sheets of chitosan which were from 7.5 μm to 15 μm in thickness with gaps of 100 μm to 200 μm between the films of chitosan.

Ten multi-layered, air-gapped sheets selected randomly from each of Examples 2 to 5 were measured for dimension, and their average values are given in Table 1.

TABLE 1
Property of Multi-layered, Air-gapped Sheet of Chitosan

| | Example No. | | | |
|---|---|---|---|---|
| Properties of Chitosan | 2 | 3 | 4 | 5 |
| Chitosan Viscos. (cps) | 11.6 | 116 | 370 | 1446 |
| Avg. Thickness of Films | 7.5 μm | 7.7 μm | 8.3 μm | 10 μm |
| Avg. Gap between Films | 89 μm | 99 μm | 134 μm | 144 μm |

### EXAMPLE 6 TO 10

### Properties of Multi-layered, Air-gapped Sheets of Chitosan According to Concentration of Chitosan Solution

In aqueous 3 wt % lactic acid solutions, chitosan which had a viscosity of 116 cps with a deacetylation degree of 94% was dissolved at amounts of 1 wt %, 2 wt %, 3 wt %, 4 wt %, and 5 wt %, respectively. From these chitosan solutions, multi-layered, air-gapped sheets of chitosan were prepared in the same manner as in Example 1. Ten multi-layered, air-gapped sheets of chitosan selected randomly from each of Examples 6 to 10 were measured for dimension, and their average values are given in Table 2.

TABLE 2

| | Example No. | | | | |
|---|---|---|---|---|---|
| Properties of Chitosan | 6 | 7 | 8 | 9 | 10 |
| Chitosan Conc. | 1 wt % | 2 wt % | 3 wt % | 4 wt % | 5 wt % |
| Avg. Thickness of Films | 7.1 μm | 7.7 μm | 7.7 μm | 14 μm | 11 μm |
| Avg. Gap between Films | 65 μm | 85 μm | 99 μm | 98 μm | 98 μm |

### EXAMPLES 11 TO 13

### Properties of Multi-layered, Air-gapped Sheets of Chitosan According to Pre-Freezing Temperatures

Multi-layered, air-gapped sheets of chitosan were prepared in a manner similar to that of Example 1 with the exception that the pre-freezing temperatures were set to be −30° C., −40° C., and −50° C., respectively. The properties of the sheets according to the pre-freezing temperatures are given in Table 3.

TABLE 3

| | Example No. | | |
|---|---|---|---|
| Condition & Properties | 11 | 12 | 13 |
| Temp. of Pre-Freezing | −30° C. | −40° C. | −50° C. |
| Avg. Thickness of Film | 14 μm | 11 μm | 11.5 μm |
| Avg. Gap between Films | 140 μm | 110 μm | 112 μm |

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. A method for manufacturing a multi-layered, air-gapped sheet of chitosan, comprising the steps of:
a) dissolving chitosan at a concentration of about 0.5% to about 30% by weight in an aqueous acidic solution, or an aqueous inorganic salt solution, or an organic solvent, or a mixture thereof, to form a chitosan solution;
b) incubating the chitosan solution at −5° C. to 50° C. for 1 to 30 days; and
c) drying the chitosan solution by a freeze-drying process.

2. The method of claim 1 further comprises of a step of freezing the chitosan solution at −10° C. to −60° C. prior to the drying step.

3. The method of claim 2, wherein the drying step is initially heating the frozen chitosan solution at 50° C. to 100° C. for about 10 minutes to about 120 minutes under a pressure of 100 Torr to 0.1 Torr.

4. The method of claim 3 further comprises of a step of cycling the chitosan solution between the freezing the chitosan solution at −10° C. to −60° C. and the heating at 50° C. to 100° C. under a pressure of 100 Torr to 0.1 Torr for about 10 minutes to about 120 minutes for each cycle.

5. The method of claim 4 further comprises of a step of cycling being done at about the same time intervals between cycles.

6. A method for manufacturing a multi-layered, air-gapped sheet of chitosan, comprising the steps of:
a) dissolving chitosan at a concentration of about 0.5% to about 30% by weight in an aqueous acidic solution, or an aqueous inorganic salt solution, or an organic solvent, or a mixture thereof, to form a chitosan solution;
b) incubating the chitosan solution at −5° C. to 50° C. for 1 to 30 days; and
c) drying the chitosan solution by a thermal drying process.

7. The method of claim 6, wherein the drying step is initially heating the chitosan solution at 50° C. to 200° C. for about 10 minutes to about 120 minutes.

8. The method of claim 7 further comprises of a step of cycling the chitosan solution between an incubating the chitosan solution at −5° C. to 50° C. and the heating at 50° C. to 200° C. for about 10 minutes to about 120 minutes for each cycle.

9. The method of claim 8 further comprises of a step of cycling being done at about the same time intervals between cycles.

10. A method for manufacturing a multi-layered, air-gap sheet of chitosan, comprising the steps of:
a) dissolving chitosan at a concentration of about 0.5% to about 30% by weight in an aqueous acidic solution, or an aqueous inorganic salt solution, or an organic solvent, or a mixture thereof, to form a chitosan solution;
b) incubating the chitosan solution at −5° C. to 50° C. for 1 to 30 days; and
c) drying the chitosan solution by a vacuum drying process.

11. The method of claim 10, wherein the drying step is initially heating the chitosan solution at 50° C. to 200° C. for about 10 minutes to about 120 minutes under a pressure of 0.1 Torr to 100 Torr.

12. The method of claim 11 further comprises of a step of cycling the chitosan solution between an incubating the chitosan solution at −5° C. to 50° C. and the heating at 50° C. to 200° C. under a pressure of 0.1 Torr to 100 Torr for about 10 minutes to about 120 minutes for each cycle.

13. The method of claim 12 further comprises of a step of cycling being done at about the same time intervals between cycles.
